(19) United States
(12) Patent Application Publication
(10) Pub. No.: US 2016/0103001 A1
(43) Pub. Date: Apr. 14, 2016

(54) METHOD OF INTERPOLATING READ-OUT SIGNAL OF INCREMENTAL ENCODER

(71) Applicant: Kabushiki Kaisha TOPCON, Tokyo (JP)

(72) Inventors: Satoshi YANOBE, Tokyo (JP); Masae MATSUMOTO, Tokyo (JP)

(21) Appl. No.: 14/876,506

(22) Filed: Oct. 6, 2015

(30) Foreign Application Priority Data
Oct. 8, 2014 (JP) 2014-206888

(51) Int. Cl. G01D 5/347

(52) U.S. Cl. CPC G01D 5/3473

(57) ABSTRACT

A rotation angle “θ” is calculated by means of an operational equation below by using a count value Ttrig i of a clock signal stored at a timing of the rise of a trigger signal output during the scanning operation of a three-dimensional scanner 1, a count value “i” of the pulsed angle signal counted immediately before the counting, count values Ti and Ti+1 of the clock signal stored at a timing of the rise of the respective angle signals which rise before and after the rising, and an angular pitch “λ” which is an angle of one pitch of plenty of slits acting as a main scale and disposed at regular intervals formed along a circular circumference of a dial board 11.

θ={i+(Ttrig i−Ti)/(Ti+1−Ti)}×θ

### CROSS-REFERENCE TO RELATED APPLICATION

This application claims priority under 35 USC 119 from Japanese Patent Application No. 2014-206888, filed Oct. 8, 2014, the disclosure of which is incorporated by reference herein.

### TECHNICAL FIELD

The present invention relates to a method of interpolating a read-out signal of an incremental encoder, and, especially, to the method of interpolating the read-out signal of the incremental encoder which is suitably used for the detection of a rotation angle of a vertical rotation of a three-dimensional scanner, that is, of a rotation using a horizontal axis as a rotation axis.

### BACKGROUND ART

In a conventional incremental encoder, two signals similar to sinusoidal waves (pseudo sine wave signals) of which phases are different from each other by 90° are generally obtained in the detecting section. An interpolation method for realizing the higher resolution performance by utilizing the above two signals is categorized into an analogue system and a digital system. The analogue system includes an analogue division system in which the above two signals having the different phases are synthesized on en electric circuit while their proportion is changed for producing signals having various phase differences so as to obtain the signals with fine pitches. However, this analogue division system possesses disadvantages that the electric circuit becomes complex for increasing the resolution performance, a mounting area is increased due to the larger circuit scale, and a cost becomes higher. When the incremental encoder is used for the detection of the rotation angle of the vertical rotation of the three-dimensional scanner, the vertical rotation speed of the three-dimensional scanner reaches several thousand rpm in addition that the higher mounting area can not be secured. The high speed rotation of this level tends to change or deteriorate the analogue characteristics due to the frequency characteristics of an amplifier so that the analogue division system is not suitable.

On the other hand, the digital system is suitable for the detection of the rotation angle of the vertical rotation of the three-dimensional scanner because the circuit scale of the digital system can be made smaller than that of the analogue division system. The digital system includes a digital interpolation system in which the above two signals having the different phases are digitally transformed to obtain the digitally transformed signals S1, S2, and the rotation angle θ is calculated by using θ=tan⁻S2/S1 which utilizes an arc tangent based on the signals S2/S1 for obtaining the angle with fine pitches, and the higher resolution performance is realized. The interpolation method which is prepared by improving the digital interpolation method, in which the resolution performance is significantly increased by calculating the position of a measured point in an interpolation region divided by means of zero points of a plurality of signals by employing a proportional operating system based on two signals selected in the above interpolation region (Patent Publication 1).

### PRIOR TECHNICAL PUBLICATIONS

### Patent Publications

Patent Publication 1: JP-B-5-24445

### SUMMARY OF INVENTION

### Problems to Be Solved By Invention

However, the conventional analogue division system including the above improved analogue division system possesses a disadvantage that, because the proportional operation is conducted based on the voltage values of the analogue signals having the two different phases to be digitally transformed, the system is subject to influence such as wave distortion of the above two signals and phase difference accuracy. Accordingly, the improved analogue division system cannot respond to the accuracy and the stability required in the vertical rotation in which the horizontal axis of the three-dimensional scanner rotates at a speed as high as several thousand rpm.

The present invention has been made to overcome these disadvantages, and an object thereof is to provide a method of interpolating a read-out signal of an incremental encoder which can maintain higher accuracy and stability even in a high speed rotation of a horizontal rotation axis of a three-dimensional scanner as high as several thousand rpm.

### Means of Solving Problems

The present invention (claim 1) for achieving the object has the configuration of a method of interpolating a read-out signal of an incremental encoder detecting a rotation angle by utilizing two pseudo sine wave signals having different phases, which are obtained from an incremental encoder including a dial board communicated with a rotation axis of a vertically rotating motor of a three-dimensional scanner, and a fixed scanning board, the method including, pulsing one of the pseudo sine wave signals as an angle signal, counting the pulsed angle signal, storing count values of a clock signal separately counted with respect to a timing of every rise of the angle signals, and with respect to a timing of every rise of signals of ordering detection of a rotation angle output from a controlling section of the three-dimensional scanner, and calculating a rotation angle “θ” at the timing of the rise of the signal of ordering the detection of the rotation angle, by means of an operational equation below by using a count value Ttrig i of the clock signal stored at the timing of the rise of the signal of ordering the detection of the rotation angle, a count value “i” of the pulsed angle signal counted immediately before the rise of the signal of ordering the detection of the rotation angle, respective count values Ti and Ti+1 of the clock signal stored at the timing of the rise of the respective angle signals which rise before and after the rise of the signal of ordering the detection of the rotation angle, and an angular pitch “λ” which is an angle of one pitch of plenty of slits acting as a main scale and disposed at regular intervals formed along a circular circumference of the dial board.

θ={i+(Ttrig i−Ti)/(Ti+1−Ti)}×λ

The method of interpolating the read-out signal of the incremental encoder of claim 2 similarly for achieving the object is characterized in that the signal of ordering the detection of the rotation angle is a trigger signal output from the controlling section of the three-dimensional scanner during a scanning operation.

In this manner, the rotation angle is calculated based on the time interval between the respective rises of the signals calculated by utilizing the count values counted at the rise of the angle signal formed by pulsing one of the pseudo sine wave signals and at the rise of the signal of ordering the detection of the rotation angle output from the controlling section of the three-dimensional scanner, for example, a trigger signal output at the time of detecting the rotation angle. Accordingly, the influences based on the wave distortion of the pseudo sine wave signals acting as the angular signal and on the accuracy of the phase difference between the other pseudo sine wave signal and itself are hardly exerted even at a higher rotation speed as high as several thousand rpm.

### Effect of Invention

In accordance with the method of interpolating the read-out signal of the incremental encoder of claim 1, an effect is produced such that the rotation angle of the vertical rotation of the three-dimensional scanner rotating at the speed as high as several thousand rpm can be detected with the high accuracy and the high stability. Further, in accordance with the method of claim 2, an effect is produced such that, in addition to the above effect, the scanning operation of the three-dimensional scanner and the operation of detecting the rotation angle are reliably coordinated because the trigger signal output during the scanning operation is used as the signal of ordering the detection of the rotation angle.

### BRIEF DESCRIPTION OF DRAWINGS

FIG. 1 A block diagram of a three-dimensional scanner in accordance with an embodiment of the present invention.

FIG. 2 A block diagram of an incremental encoder which reads out a vertical rotation angle in accordance with the above embodiment.

FIG. 3 A timing chart showing an operation of processing a read-out signal in accordance with the above embodiment.

### EMBODIMENTS FOR IMPLEMENTING INVENTION

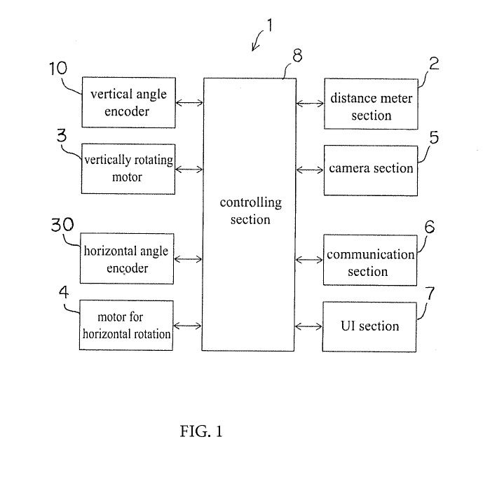

One embodiment of the present invention will be described referring to the annexed drawings. As shown in FIG. 1, a three-dimensional scanner 1 includes a motor 3 for vertically rotating a scanner section (not shown) including a laser opening and configuring part of a distance meter 2, and a motor 4 for horizontally rotating the scanner section. While a dial board 11 of a vertical angle encoder 10 is equipped to the rotation axis of the vertically rotating motor 3, a dial board (not shown) of a horizontal angle encoder 30 is equipped to the rotation axis of the horizontally rotating motor 4. The distance meter 2 is configured to perform the scanning operation by irradiating distance-measuring laser which is a pulsed wave from the above laser opening not shown and by receiving its reflected wave, and its scanning range is arbitrarily established.

The three-dimensional scanner 1 automatically shoots the entire scanning range at the scanning operation, and stores it as photo data in an image file, and includes a camera section 5 displaying the photo data on a monitor depending on necessity, a communication section 6 sending and receiving various signals and data between an external device (not shown) and itself, and a UI (user interface) section 7 including a monitor, a touch panel and an operation key. All the operations of the three-dimensional scanner 1 including the scanning operation are controlled by a controlling section 8, and the scanning operation is conducted by a trigger signal which orders the irradiation of distance-measuring laser. The present embodiment utilizes the trigger signal as a signal of ordering the detection of the rotation angle.

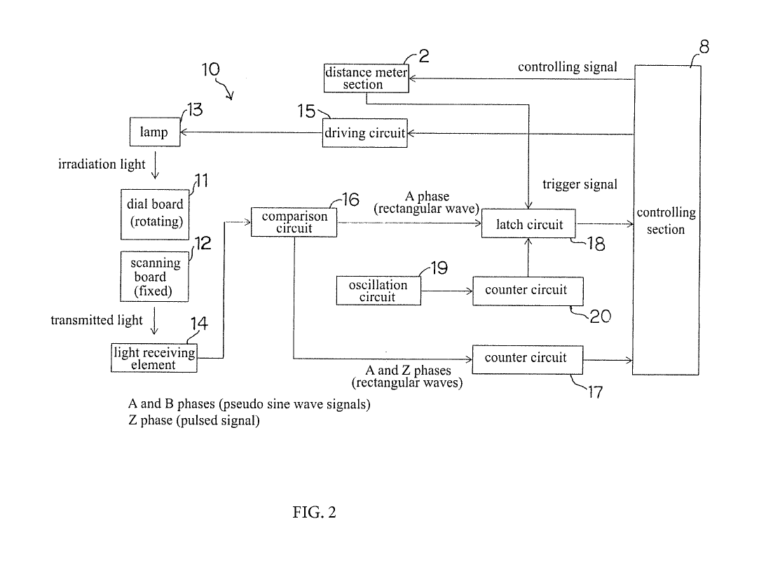

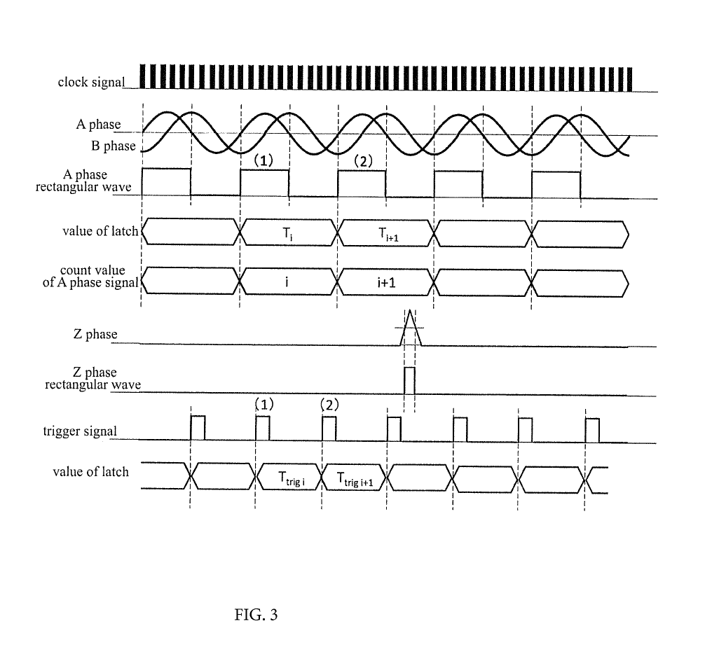

As shown in FIG. 2, in the vertical angle encoder 10, a scanning board 12 which is fixed with respect of the dial board 11 rotating with the rotation axis of the vertically rotating motor 3 is disposed facing to the above dial board 11. The irradiation light emitted from a lamp 13 passes through slots formed in the dial board 11 and the scanning board 12 and reaches a light receiving element 14, thereby outputting A and B phase signals which are two pseudo sine wave signals of which phases are different from each other by 90°, and a pulse-shaped Z-phase signal which is an origin signal output with respect to each rotation of the dial board 11 (refer to FIG. 3).

In the present embodiment, the A phase signal of the two kinds of the pseudo sine wave signals is used as an angle signal while the B phase signal is used for detecting the direction of rotation. The irradiation light from the lamp 13 is on-off controlled by a drive signal of a drive circuit 15 receiving a control signal of the controlling section 8, and all of the operations of the vertical angle encoder 10 are controlled by the above controlling section 8. The configuration of the horizontal angle encoder 30 is known, and its operation includes no difference from that of a conventional incremental encoder. Further, the method of interpolation of the present invention is not applied to the encoder 30 so that the detailed description is omitted.

Then, the configuration of the interpolating operation will be described based on FIG. 2. The pseudo sine wave signals of the And B phases are input into a comparison circuit 16, and the comparison circuit 16 is configured to output the respective signals as rectangular waves (refer to FIG. 3). Since B phase signal is not directly involved in the method of interpolation of the present invention, the description of the B phase signal in the subsequent operations will be omitted. The A and Z phase signals pulsed as the rectangular waves output from the comparator circuit 16 are counted as inputs in a counter circuit 17, and the counted values are configured to be input from the counter circuit 17 to the controlling section 8. The count value of the pulsed A phase signal is configured to be reset to zero when the Z phase signal which is the origin signal is input into the counter circuit 17. The A phase signal output from the comparator circuit 16 is configured to be input also into a latch circuit 18.

Then, the method of interpolation will be described referring to FIGS. 2 and 3. Among the A and B phase signals and the Z phase signal detected in the vertical angle encoder 10, the A phase signal which is the pseudo sine wave signal and the Z phase signal which is the pulsed signal are pulsed to the rectangular shapes in the comparator circuit 16, and the subsequent operations are performed using the A phase signal as an angle signal. The A phase rectangular wave signal which is the pulsed angle signal is counted at the counter circuit 17, and the count values i, i+1. . . are input into the controlling section 8. The count values of these count values of the A phase rectangular wave signal are reset to zero when the Z phase signal which is the origin signal is input into the counter circuit 17.

On the other hand, a clock signal produced in an oscillation circuit 19 is counted at a count circuit 20, and the count values Ti, Ti+1. . . are stored at the latch circuit 18 with respect to every rise of the A phase rectangular wave signal. When the trigger signal which is output from the controlling section 8 of the three-dimensional scanner 1 through the distance meter section 2 during the scanning operation and is the signal of ordering the detection of the rotation angle, the count values Ttrig i, Ttrig i+1 . . . of the clock signal with respect to every timing of the rise of the trigger signal are stored in the above latch circuit 18. These stored count values are output from the latch circuit 18 to the controlling section 8.

When the count value of the A phase rectangular wave signal (1) input into the controlling section 8 is defined to be “i”, the count value of the clock signal stored at the timing of the rise of the A phase rectangular wave signal input into the controlling section 8 is similarly defined to be “Ti”, the count value of the clock signal stored at the timing of the rise of the A phase rectangular wave signal (1) input into the controlling section 8 is similarly defined to be “Ttrig i”, the count value of the clock signal stored at the timing of the rise of the A phase rectangular wave signal (2) input into the controlling section 8 next to the above count value “Ti” is similarly defined to be “Ti+1”, and an angular pitch which is an angle of one pitch of plenty of slits acting as a main scale and disposed at regular intervals formed along the circular circumference of the dial board 11 already input into the controlling section 8 is defined to be “λ”, a rotation angle from the rise of the A phase rectangular wave signal (1) to the rise of the trigger signal (1) at the input of the trigger signal (1) is expressed as {(Ttrig i−Ti)/(Ti+1−Ti)} ×λ. Accordingly, a rotation angle θ of one cycle from an initial point to a detection point the interpolation is conducted in this case is expressed by using an operational equation of θ={i+(Ttrig i−Ti)/(Ti+1−Ti)}×λ

The “θ” is the angle of one pitch of the main scale of the dial board 11 and may be input into the controlling section 8 after the calculation thereof. The controlling section 8 calculates the rotation angle “θ” by using the respective count values “i”, Ttrig 1, Ti, and Ti+1 and the above “λ” input in advance by using the above operational equation with respect to every output of the trigger signal.

When the rotation angle “θ” is calculated by using the output of the trigger signal (2), an operational equation of θ={i+(Ttrig i−Ti)/(Ti+1−Ti)}×λ is employed. In this manner, the rotation angle “0” can be calculated with respect to every timing of the input of the trigger signal which is the signal of ordering the detection of the rotation angle into the latch circuit 18 in the present embodiment.

The present invention shall not be restricted to the above embodiments, and, for example, in place of the trigger signal output from the controlling section 8 during the scanning operation, another output signal may be employed as the signal of ordering the detection of the rotation angle. The dial board 11 may be not only directly equipped to the rotation axis of the vertically rotating motor 3, but also indirectly equipped such that the dial board 11 rotates always at an equal speed as that of the rotation axis.

### DESCRIPTION OF SYMBOLS

1 . . . three-dimensional scanner
2 . . . distance meter section
3 . . . vertically rotating motor
8 . . . controlling section
10 . . . vertical angle encoder
11 . . . dial board
12 . . . scanning board
13 . . . lamp
14 . . . light receiving element
15 . . . driving circuit
16 . . . comparison circuit
17, 20 . . . counter circuit
18 . . . latch circuit
19 . . . oscillation circuit

1. A method of interpolating a read-out signal of an incremental encoder detecting a rotation angle by utilizing two pseudo sine wave signals having different phases, which are obtained from an incremental encoder including a dial board communicated with a rotation axis of a vertically rotating motor of a three-dimensional scanner, and a fixed scanning board, the method comprising:
pulsing one of the pseudo sine wave signals as an angle signal;
counting the pulsed angle signal;
storing count values of a clock signal separately counted with respect to a timing of every rise of the angle signals, and with respect to a timing of every rise of signals of ordering detection of a rotation angle output from a controlling section of the three-dimensional scanner; and
calculating a rotation angle “θ” at the timing of the rise of the signal of ordering the detection of the rotation angle, by means of an operational equation below by using a count value Ttrig i of the clock signal stored at the timing of the rise of the signal of ordering the detection of the rotation angle, a count value “i” of the pulsed angle signal counted immediately before the rise of the signal of ordering the detection of the rotation angle, respective count values Ti and Ti+1 of the clock signal stored at the timing of the rise of the respective angle signals which rise before and after the rise of the signal of ordering the detection of the rotation angle, and an angular pitch “λ” which is an angle of one pitch of plenty of slits acting as a main scale and disposed at regular intervals formed along a circular circumference of the dial board.
θ={i+(Ttrig i−Ti)/(Ti+1−Ti)}×λ

2. The method of interpolating the read-out signal of the incremental encoder as claimed in claim 1, wherein the signal of ordering the detection of the rotation angle is a trigger signal output from the controlling section of the three-dimensional scanner during a scanning operation.
